(19) United States
(12) Patent Application Publication
(10) Pub. No.: US 2007/0008175 A1
(43) Pub. Date: Jan. 11, 2007

(54) Siren detection notification alarm

(76) Inventors: Duane Johnson, Pensacola, FL (US); Keith Johnson, Pensacola, FL (US)

Correspondence Address: John Wiley Horton, Attorney;Pennington, Moore, Wilkinson, Bell & Dunbar, P.A., 2nd Floor, 215 S. Monore St., Tallahassee, FL, 32301, US

(21) Appl. No.: 11/176,935

(22) Filed: Jul. 6, 2005

(51) Int. Cl. G08G 1/00

(52) U.S. Cl. 340/902

(57) ABSTRACT

A new siren detection notification alarm for an automobile. The system includes an input transducer which converts ambient sounds into an electrical signal and transmits the signal to an electric circuit. The electric circuit includes a decibel level detector and a combination bandpass filter and time counter. If the electrical signal exceeds the design intensity level and is in the design frequency range for the design period of time, a notification alarm is triggered. The notification alarm can be a visual or audible alarm or a combination of both.

### BACKGROUND OF THE INVENTION

1. Field of the Invention

This invention relates to the field of notification alarms. More specifically, the invention comprises a system for notifying a driver when a siren is detected.

2. Description of the Related Art

Advancements in automotive design have drastically improved vehicle sound proofing. Vehicles are equipped with better insulation and seals that limit the amount of road and engine noise to which occupants are exposed. Although these advancements have made riding more comfortable for many people, the advancements have mitigated the effectiveness of high frequency sirens emitted by emergency response vehicles such as police cars, ambulances, and fire trucks. Furthermore, it is common for drivers to listen to the radio or converse on cellular telephones while driving, further impairing their ability to hear these sirens. It is generally desirable for drivers to hear these sirens in order to clear the roadway for the approaching emergency response vehicle.

Some inventors have proposed solutions to this problem, including radio signal transmitter-receiver systems, as exemplified by U.S. Pat. No. 6,362,749 B1 to Brill. These systems generally provide a signal transmission source on an emergency response vehicle and a signal receiving source on standard civilian vehicles. The emergency response vehicle emits a radio frequency signal to alert civilian vehicles to its presence.

Other inventors have proposed mechanisms to detect sirens by collecting ambient sounds with an input transducer and comparing the wave characteristics with known siren characteristics. An example of this kind of system is disclosed in U.S. Pat. No. 5,710,555 to McConnell et al. As illustrated in McConnell et al., these systems are used to change street lights to allow emergency response vehicles to pass rapidly through intersections. These siren detection systems have disadvantages, however. The system only detects sirens with frequency and warble rates in its designed range. This can cause undesirable false negatives when a siren falls outside of the design range. Furthermore, the apparent signal—the signal detected by the detector system—may not always resemble the signal emitted from the emergency response vehicle. The presence of buildings and other reverberant structures can cause echoes and other artifacts that can throw the detection system off. Accordingly it would be desirable to have a detection system that is less prone to false negatives and can be used to alert a driver of the presence of a siren emitted from an emergency response vehicle.

### BRIEF SUMMARY OF THE PRESENT INVENTION

The present invention comprises a new siren detection notification alarm for an automobile. The system includes an input transducer which converts ambient sounds into an electrical signal and transmits the signal to an electric circuit. The electric circuit includes a decibel level detector and a combination bandpass filter and time counter. If the electrical signal exceeds the design intensity level and is in the design frequency range for the design period of time, a notification alarm is triggered. The notification alarm can be a visual or audible alarm or a combination of both.

### BRIEF DESCRIPTION OF THE SEVERAL VIEWS OF THE DRAWINGS

FIG. 1 is a schematic showing the present invention.

FIG. 2 is a schematic showing the present invention.

FIG. 3 is a graph of an idealized yelp siren.

FIG. 4 is a graph of an idealized high-low siren

FIG. 5 is a graph of an idealized wail siren.

FIG. 6 is a graph illustrating operation of the bandpass filter and time counter.

FIG. 7 is a graph illustrating operation of the decibel level detector.

### REFERENCE NUMERALS IN THE DRAWINGS

10 siren detection notification alarm 12 input transducer

14 bandpass filter 16 time counter

18 decibel level detector 20 power source

22 alarm means 24 switch

26 switch 28 logic element

30 preamplifier 32 idealized yelp siren

34 idealized high-low siren 36 idealized wail siren

38 bandpass design threshold 40 design period of time

42 activating time 44 design intensity threshold

46 activating time 48 ambient sound intensity

50 activating signal 52 activating signal

### DESCRIPTION OF THE INVENTION

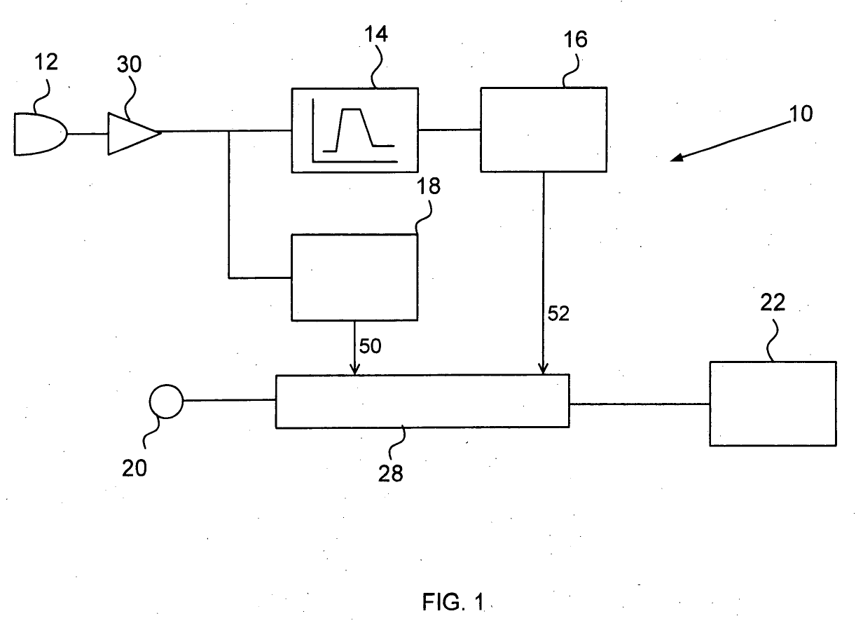

A schematic for the present invention, siren detection notification alarm 10, is shown in FIG. 1. Siren detection notification alarm 10 generally includes input transducer 12, bandpass filter 14, time counter 16, and decibel level detector 18, connected in an electric circuit. Input transducer 12 is configured to convert ambient sounds into electrical signals. A microphone is a common example of a device that can be used for input transducer 12. Preamplifier 30 is used to amplify the electrical signals transmitted by input transducer 12.

In the preferred embodiment, the electrical signals transmitted by input transducer 12 and preamplifier 30 are further transmitted through two separate paths. The first path includes bandpass filter 14 and time counter 16. Bandpass filter 14 is configured to transmit a design range of frequencies and block the transmission of frequencies above or below the design thresholds. Electrical signals that pass bandpass filter 14 are transmitted to time counter 16. Time counter 16 is configured to track the length of time bandpass filter 14 is transmitting electrical signals. Time counter 16 is further configured to transmit activating signal 52 when time counter 16 observes the relative continuous transmission of electrical signals from bandpass filter 14 within the design frequency range of bandpass filter 14 for a design period of time. Time counter 16 can be any means that is adapted to observe the transmission of electrical signals from bandpass filter 14 in order to determine if bandpass filter 14 transmits electrical signals for a design period of time.

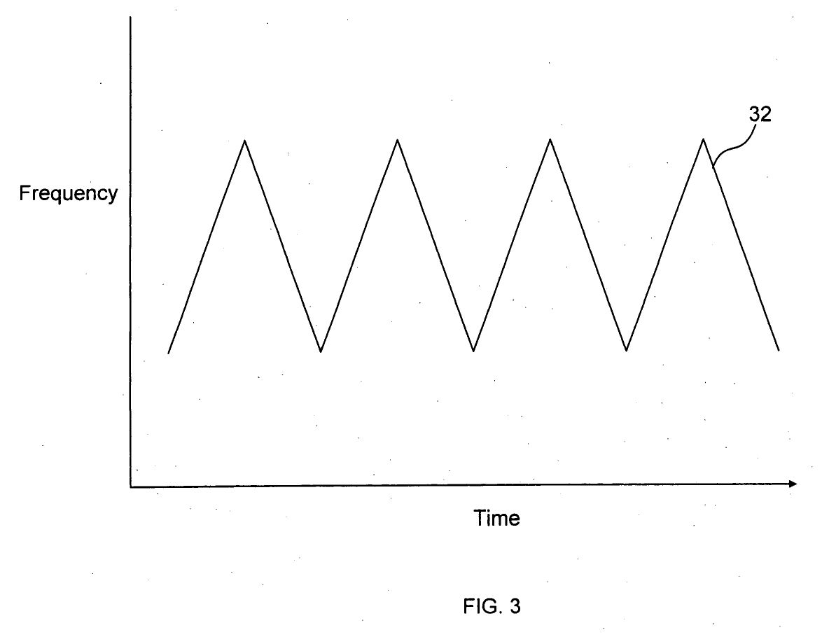

Most sirens range in frequency between 400 Hz to 1600 Hz. Three common siren types—yelp, high-low, and wail—are illustrated in FIGS. 3-5. As shown in FIG. 3, idealized yelp siren 32 oscillates between a minimum and maximum frequency. Idealized yelp siren 32 typically has a minimum frequency of 400 Hz and a maximum frequency of 1400 Hz with a repetition rate of approximately 3 Hz.

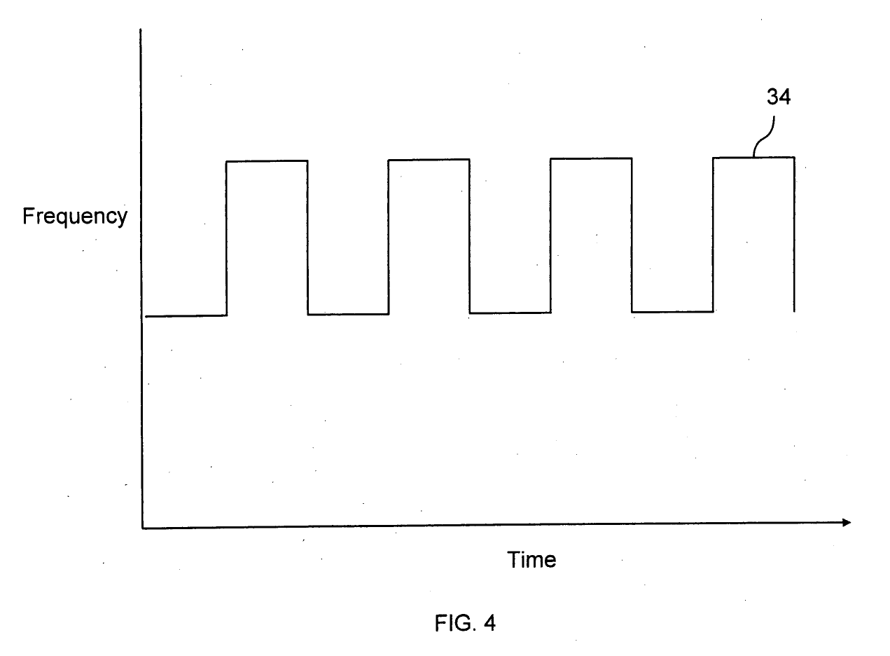

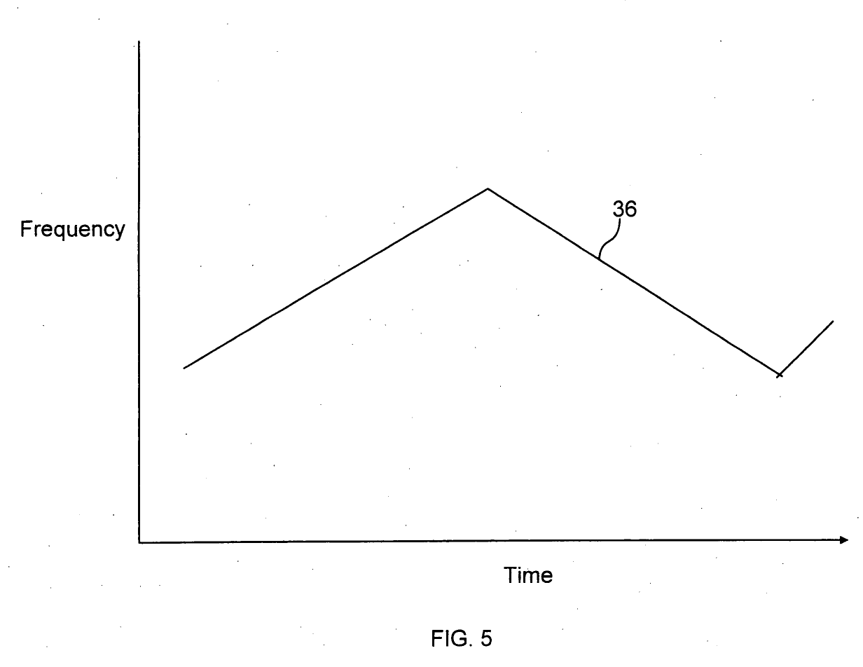

As shown in FIG. 4, idealized high-low siren 34 alternates between two tones. Idealized high-low siren 34 has a minimum frequency of 400 Hz and a maximum frequency of 600 Hz with a repetition rate of approximately 1 Hz. Idealized wail siren 36 is shown in FIG. 5. Like idealized yelp siren 32, idealized wail siren 36 oscillates between a minimum frequency of 400 Hz and a maximum frequency of 1400 Hz, except idealized wail siren 36 has a repetition rate of approximately 0.25 Hz. Actual sirens have characteristics which are not illustrated in FIGS. 3-5, but the general properties of the aforementioned idealized sirens are representative of actual sirens.

As previously mentioned, bandpass filter 14 has a design frequency range or passband. In order to detect the previously mentioned varieties of sirens, a design frequency range of 300 Hz to 1600 Hz has proven effective. As illustrated in FIG. 1, time counter 16 receives electrical signals falling in the design frequency range of bandpass filter 14. Time counter 16 monitors for the substantially continuous transmission of electrical signals from bandpass filter 14 for a design period of time. In the preferred embodiment of the present invention, the design period of time is 1.5 seconds or greater. A shorter period of time would also work but would be more likely to detect false positives, such as tires squealing, brakes screeching, and other road noises. Time counter 16 transmits activating signal 52 when it receives electrical signals in the design frequency range for the design period of time.

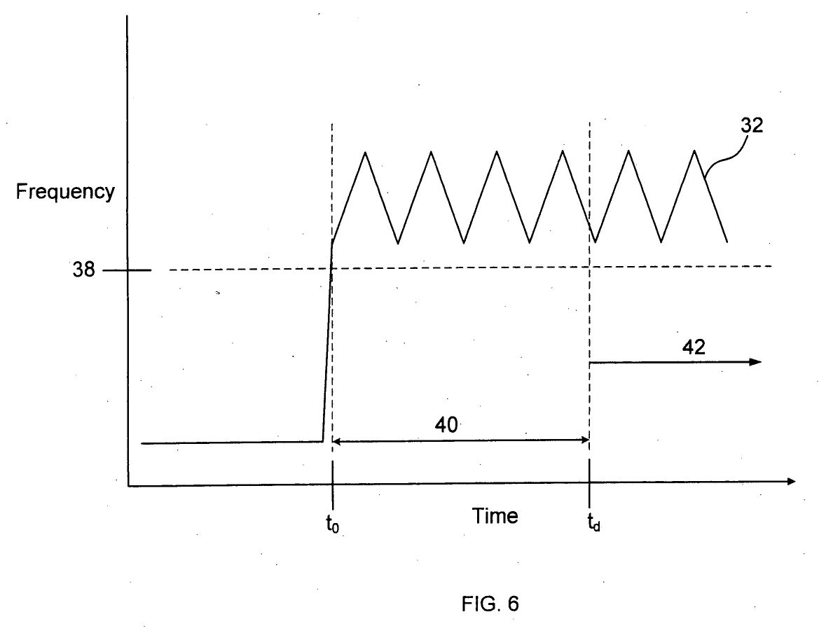

FIG. 6 better illustrates the operation of bandpass filter 14 and time counter 16. FIG. 6 shows a scenario where a siren is detected by the aforementioned process. Input transducer 12 picks up a siren, idealized yelp siren 32, at t₀. Since idealized yelp siren 32 is over bandpass design threshold 38, bandpass filter 14 further transmits the electrical signals to time counter 16. From t₀ to t_{d}, time counter 16 observes the continuous transmission of electrical signals from bandpass filter 14. This observation period corresponds to design period of time 40, so at time t_{d} time counter 16 transmits activating signal 52. Time counter 16 continues to transmit activating signal 52 throughout activating time 42 as long as bandpass filter 14 continues to transmit electrical signals.

The second path involves decibel level detector 18 which measures the intensity of the electrical signals. Decibel level detector 18 is configured to transmit activating signal 50 when decibel level detector 18 observes an electrical signal exceeding its design intensity threshold. Those that are skilled in the art know that sirens emitted by emergency response vehicles are emitted at near constant amplitude. From the perspective of siren detection notification alarm 10, the loudness of the siren is a function of the distance of the siren from input transducer 12. Accordingly, decibel level detector 18 is calibrated to have a design intensity threshold that, when taking into account the location and sensitivity of input transducer 12, timely “detects” the presence of a siren.

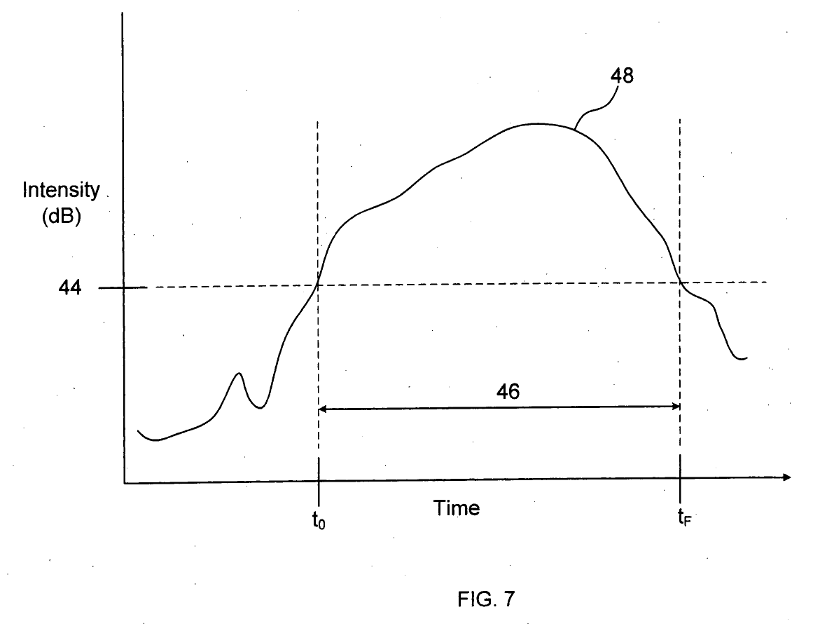

The operation of decibel level detector 18 is better illustrated in FIG. 7. FIG. 7 shows ambient sound intensity 48 which is transmitted by input transducer 12 and amplified by preamplifier 30. At to, ambient sound intensity 48 exceeds design intensity threshold 44. Accordingly, at t₀, decibel level detector 18 transmits activating signal 50. Decibel level detector 15 continues to transmit activating signal 50 as long as ambient sound intensity 48 exceeds design intensity threshold 44. In FIG. 7, this period of time is denoted as activating time 46. Activating time 46 continues until ambient sound intensity 48 no longer exceeds design intensity threshold 44 at time t_{F}.

As illustrated in FIG. 1, time counter 16 and decibel level detector 18 transmit activating signals 52 and 50, respectively, to logic element 28. Logic element 28 acts as a switching means and connects alarm means 22 with power source 20 when logic element 28 concurrently receives activating signals 52 and 50. Logic element 28 can also be configured with more elaborate protocols to limit false positives and false negatives. For example, logic element 28 can be configured to connect alarm means 22 with power source 20 even when activating signals 52 and 50 are not received concurrently. Instead logic element 28 can be configured to connect alarm means 22 with power source 20 when activating signals 52 and 50 are received in close succession.

The reader will appreciate that in the embodiment illustrated FIG. 1, logic element 28 can be configured to switch alarm means 22 to “off” when either the frequency or intensity no longer matches the design characteristics (i.e. when either activating signal 52 or activating signal 50 is no longer transmitted). Furthermore, logic element 28 can be configured to reset time counter 16 when the sound intensity falls below the design threshold. In such a configuration, time counter 16 would have to observe frequencies in the design range for the design period of time before transmitting activating signal 52 again.

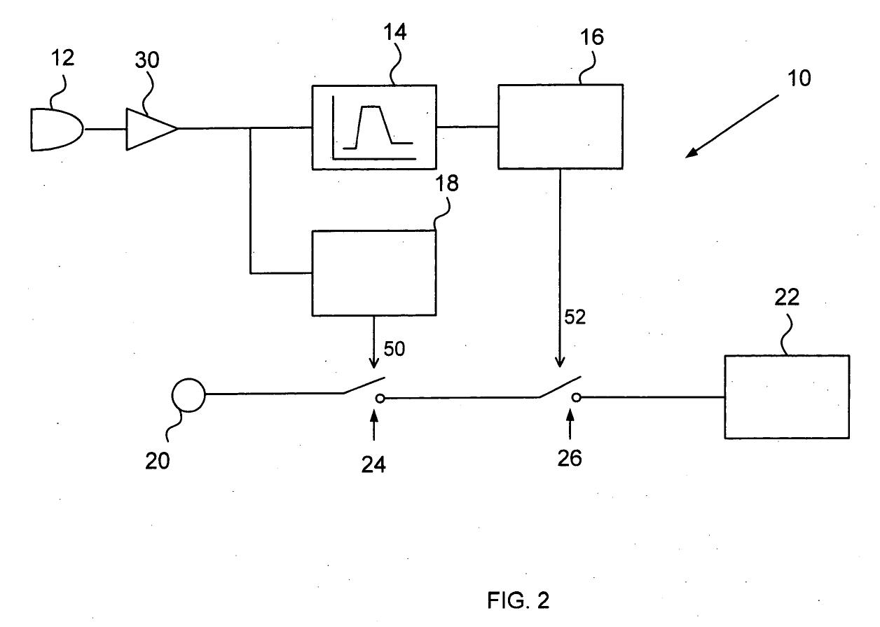

FIG. 2 illustrates how logic element 28 can also be replaced with switches 24 and 26. In the example shown in FIG. 2, switch 24 and switch 26 are normally open so that alarm means 22 is off in the default. Switch 24 and switch 26 are configured to close the circuit between power source 20 and alarm means 22 when activating signals 50 and 52 are transmitted. A simple low voltage relay is an example of a device that can be used for switches 24 and 26.

Alarm means 22 can be any sort of device that is adapted for notifying the driver that a siren has been detected. Examples include flashing lights placed in a highly visible location, an audible alarm, a prerecorded warning message, or a combination if any of the previous.

Although the preceding descriptions contain significant detail they should not be viewed as limiting the invention but rather as providing examples of the preferred embodiments of the invention. As one example, various switching means can be used for logic element 28 or switches 24 and 26. Changing the configuration of the switching means, however, does not depart from the spirit and scope of the invention. Accordingly, the scope of the invention should be determined by the following claims, rather than the examples given.

Having described our invention, we claim:

1. A siren detection notification alarm for detecting a siren emitted by an emergency response vehicle, said siren detection notification alarm carried in a civilian vehicle driven by a driver, comprising:
a. an input transducer, said input transducer configured to convert ambient sounds into electrical signals and transmit said electrical signals to an electric circuit;
b. a bandpass filter, said bandpass filter electrically connected to said electric circuit and configured to transmit a design range of frequencies corresponding to frequencies of said siren;
c. a time counter, said time counter electrically connected to said electric circuit and configured to transmit a first activating signal when said bandpass filter transmits electric signals falling within its design range of frequencies for a design period of time;
d. a decibel level detector, said decibel level detector connected to said electric circuit and configured to transmit a second activating signal when said electrical signals transmitted by said input transducer exceed a design intensity threshold;
e. an alarm means, said alarm means adapted to notify said driver when said siren is detected; and
f. a switching means, said switching means configured to activate said alarm means when said decibel level detector transmits said second activating signal substantially concurrently with said time counter transmitting said first activating signal.

2. The siren detection notification alarm of claim 1, wherein said design range of frequencies includes frequencies in the range of 300 Hz to 1600 Hz.

3. The siren detection notification alarm of claim 1, wherein said design period of time is 1.5 seconds or greater.

4. The siren detection notification alarm of claim 2, wherein said design period of time is 1.5 seconds or greater.

5. A siren detection notification alarm for detecting a siren emitted by an emergency response vehicle, said siren detection notification alarm carried in a civilian vehicle driven by a driver, comprising:
a. an input transducer, said input transducer configured to convert ambient sounds into electrical signals representative of said ambient sounds and transmit said electrical signals to an electric circuit;
b. a bandpass filter, said bandpass filter electrically connected to said electric circuit and said input transducer, said bandpass filter configured to transmit a design range of frequencies corresponding to frequencies of said siren; and
c. a time counter, said time counter electrically connected to said electric circuit and configured to transmit a first activating signal when said bandpass filter transmits electric signals falling within its design range of frequencies for a design period of time.

6. The siren detection notification alarm of claim 5, further comprising a decibel level detector, said decibel level detector connected to said electric circuit and configured to transmit a second activating signal when said electrical signals transmitted by said input transducer exceed a design intensity threshold.

7. The siren detection notification alarm of claim 5, further comprising:
a. an alarm means, said alarm means adapted to notify said driver when said siren is detected; and
b. a switching means, said switching means configured to activate said alarm means when said decibel level detector transmits said second activating signal substantially concurrently with said time counter transmitting said first activating signal.

8. The siren detection notification alarm of claim 6, further comprising:
a. an alarm means, said alarm means adapted to notify said driver when said siren is detected; and
b. a switching means, said switching means configured to activate said alarm means when said decibel level detector transmits said second activating signal substantially concurrently with said time counter transmitting said first activating signal.

9. A siren detection notification alarm detecting a siren emitted by an emergency response vehicle, said siren detection notification alarm carried in a civilian vehicle driven by a driver, comprising:
a. an input transducer, said input transducer configured to convert ambient sounds into electrical signals representative of said ambient sounds and transmit said electrical signals to an electric circuit;
b. a filtering means configured to transmit a design range of frequencies representative of said frequencies of said siren and reject frequencies falling outside of said design range;
c. a timing means configured to observe the transmission of frequencies from said filtering means and determine when said filtering means has transmitted electrical signals falling within said design range for a design period of time.

10. The siren detection notification alarm of claim 9, further comprising an intensity measuring means configured to measure the intensity of electrical signals transmitted by said input transducer.

11. The siren detection notification alarm of claim 9, further comprising:
a. an alarm means, said alarm means adapted to notify said driver when said siren is detected; and
b. a switching means, said switching means configured to activate said alarm means when said decibel level detector transmits said second activating signal substantially concurrently with said time counter transmitting said first activating signal.

12. The siren detection notification alarm of claim 10, further comprising:
a. an alarm means, said alarm means adapted to notify said driver when said siren is detected; and
b. a switching means, said switching means configured to activate said alarm means when said decibel level detector transmits said second activating signal substantially concurrently with said time counter transmitting said first activating signal.

13. The siren detection notification alarm of claim 9, wherein said design range of frequencies includes frequencies in the range of 300 Hz to 1600 Hz.

14. The siren detection notification alarm of claim 10, wherein said design range of frequencies includes frequencies in the range of 300 Hz to 1600 Hz.

15. The siren detection notification alarm of claim 9, wherein said design period of time is 1.5 seconds or greater.

16. The siren detection notification alarm of claim 10, wherein said design period of time is 1.5 seconds or greater.
